(19) United States
(12) Patent Application Publication
(10) Pub. No.: US 2001/0039856 A1
(43) Pub. Date: Nov. 15, 2001

(54) MULTIPURPOSE SCREW

(76) Inventors: RAMON BRUCART PUIG, BARCELONA (ES); MARTA BONICH LINARES, BARCELONA (ES)

Correspondence Address: STRIKER, STRIKER & STENBY, 103 EAST NECK ROAD, HUNTINGTON, NY, 11743

(21) Appl. No.: 09/252,603

(22) Filed: Feb. 17, 1999

(30) Foreign Application Priority Data
Feb. 17, 1998 (ES) 98 00 323

(51) Int. Cl. B67B 7/04

(52) U.S. Cl. 81/3.47

(57) ABSTRACT

This corkscrew consists of a main body (1) fitted to a foldable blade (7) to open bottles, a helicoidal screw (2) and a guide (4) over which is fitted a detachable arm (3) having an end nail (3a) providing a point of support over the bottle neck during uncorking. The arm (3) may be placed, with the aid of a curved retainer (5) and helicoidal spring (6), in a front or rear position.

### OBJECT OF THE INVENTION

The present invention, as the title indicates, refers to a multipurpose corkscrew, of the type having a main body for holding and using thereof, a helicoidal screw to be introduced into the cork and an arm with an end nail providing a support over the bottle neck during its uncorking.

### BACKGROUND OP THE INVENTION

In corkscrews of the mentioned type, both the screw and the arm are joined to the main body and with the possibility of folding them with respect to said body.

For reasons of size and structure, these corkscrews have a general problem in that by means of activating the main body only a partial removal of the cork is achieved, having to finish the removal, by pulling the cork out manually. This brings about an important problem for users and especially those not having enough strength to bring about complete removal.

### DESCRIPTION OF THE INVENTION

To solve the mentioned problem, the multipurpose corkscrew object of the present invention has been designed with great constructive simplicity, allowing the main body to be used as a lever both in the initial removal phase, which is common, and in the final phase.

According to the invention, the arm forming the point of support of the corkscrew over the bottle neck is joined to the main body by means of a foldable guide which may be moved longitudinally, being it possible to arrange the arm in a rear or forward position.

The possibility of arranging the arm in the two mentioned positions, allows it to be used as a point of support, both in the initial phase and in the final phase of cork removal, using the corkscrew as a level in both phases.

This particularly contributes an advantage as compared with conventional corkscrews since it is not necessary to apply additional force to finish removal of the cork.

This corkscrew is provided with rolling means permitting the arm to be maintained in the forward position as indicated above and elastic means tending to displace the arm to a rear position.

In accordance with the invention, the rolling means destined to maintain the arm in the forward position consists of a curved retainer fitted over the main body and having the possibility of being rotated.

The elastic means tending to maintain the arm in the rear position consists of a helicoidal spring whose ends are fixed to lugs defined in the arm itself and in the corresponding guide.

When the retainer is in a non-operational position, its end is above the arm and may be used to remove crown type stoppers.

Normally, the arm is in the rear position due to the action of the spring, being used in this position to perform the initial removal of the cork. To use it as a point of support during the rest of the removal, it will be sufficient to displace it towards the forward position and fold the retainer which will act with its end against the oblique fin defined in the rear end of the arm, in this way preventing the arm from receding due to action of the spring.

### DESCRIPTION OF THE DRAWINGS

To complete the description being made and with the purpose of providing a greater understanding of the invention characteristics, this specification is accompanied by a Bet of drawings, where, for illustrative purposes which in no way are limiting, the following is shown:

FIG. 1 shows an elevation view of the totally closed corkscrew.

FIG. 2 shows an elevation view of the open corkscrew and with the arm in the rear position.

FIG. 3 shows an elevation view of the open corkscrew and with the arm in the forward position.

FIG. 4 shows an inside, side view of the arm and guide joined to the main body. In this figure, the elastic means tending to maintain the arm in the rear position are seen.

### PREFERRED EMBODIMENT OF THE INVENTION

The multipurpose corkscrew, object of this invention comprise a main body (1) to which are joined, with the possibility of being folded, a helicoidal screw (2), destined to be introduced in the cork to be removed and an arm (3) with an end nail (3a) forming a support over the bottleneck during uncorking.

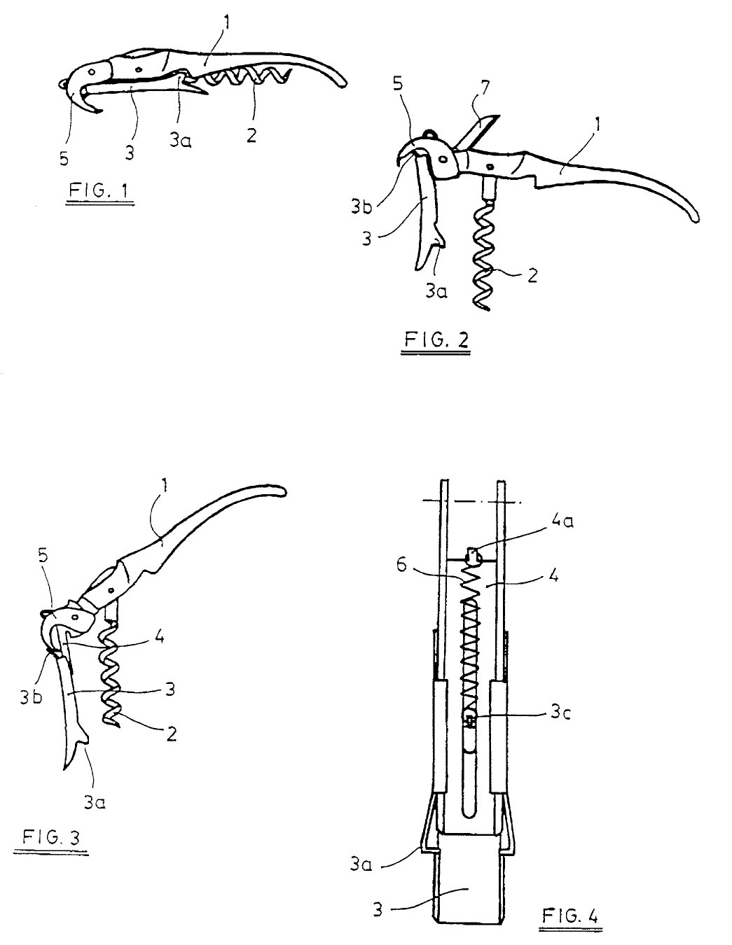

The arm (3) is joined to the main body by means of a foldable guide (4), over which it is fitted with the possibility of longitudinal movement, being it possible to arrange the arm (3) in a rear position (FIGS. 1 and 2) to partially remove the cork or in a forward position (FIG. 3) to totally remove it.

To permit the arrangement of the arm (3) in any of the positions indicated, the corkscrew includes a curved retainer (5) and a helicoidal spring (6).

The retainer (5), fitted over the main body (1) with the possibility of rotation, may be arranged in a non-operational position (FIGS. 1 and 2), then acting as a component to remove crown type stoppers, or in an operational position (FIG. 3) acting against an oblique fin (3b), defined in the rear end of the arm (3) and maintaining said arm in the front position.

The helicoidal spring (6) acts with its ends over the lugs (3c and 4a) defined in the arm (3) and in the guide (4), the purpose of said spring being to pull the arm (3) towards the rear position.

As may be observed in FIG. 2, the corkscrew also includes a foldable blade (7) to facilitate the prior lifting of the cork before opening.

With the mentioned components, to remove a cork from a bottle, first of all it is necessary to arrange the arm (3) in the rear position, support the nail over the bottle neck and make a lever with the body (1) until part of the cork is removed. Then the arm (3) is displaced over the guide (4), overcoming the resistance of the spring (6) and it is blocked by the retainer (5) in the advanced position which will allow it, due to the greater distance between the nail (3a) and the body (1), to complete the total removal of the cork, once the nail (3a) is supported over the bottleneck and the main body (1) activated as a lever.

It is not considered necessary to extend this description more for any expert in the matter to understand the scope of the invention and the advantages derived from it.

The terms in which this specification has been drafted should always be interpreted in the widest sense and not limited in any way.

The materials, shape, size and arrangement of the components may be changed provided this does not suppose an alteration of the basic characteristics of the invention, claimed below.

1. A multipurpose corkscrew, of the type comprising a main body (1), to which is joined, in a foldable manner, a blade (7) for the lifting of crown corks, a helicoidal screw (2), destined to be introduced in the cork and an arm (3) with an extreme nail (3a) forming a support over the bottleneck during uncorking thereof; characterised in that the arm (3) is joined to the main body by means of a foldable guide (4), over which it is fitted with the possibility of longitudinal displacement, being it possible to arrange the arm (3) in a rear position for the partial removal of the cork or in a forward position for its total removal. Likewise, it is characterised in that it includes rolling means to maintain the arm in the forward position and elastic means tending to displace it towards the rear position.

2. A corkscrew, according to the previous claim characterised in that the rolling means destined to maintain the arm in the forward position consist of a curved retainer (5) fitted with the possibility of rotation over the main body (1), being it possible to activate said retainer whenever necessary, as a means for removing crown type corks.

3. A corkscrew, according to the previous claims characterised in that the arm (3) has at its end an oblique fin (3b) destined to act against the retainer (5) when in the forward position.

4. A corkscrew, according to the previous claims characterised in that the elastic means tending to maintain the arm in the rear position consist of a helicoidal spring (6) whose ends are fixed to the lugs (3c and 4a) respectively defined in the arm (3) and in the guide (4).
